(19) United States
(12) Patent Application Publication
(10) Pub. No.: US 2010/0086639 A1
(43) Pub. Date: Apr. 8, 2010

(54) Dough Product, Microwaveable Frozen Bread Product, and Method For Making Same

(76) Inventors: Yayu Sophia Pai, Lombard, IL (US); Steven Paul Greiner, Mundelein, IL (US); Jeremy Scott Hardwick, Highland Park, IL (US); Erik Strilich, Roselle, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 12/553,830

(22) Filed: Sep. 3, 2009

Related U.S. Application Data
(60) Provisional application No. 61/094,957, filed on Sep. 7, 2008.
(60) Provisional application No. 61/094,955, filed on Sep. 7, 2008.

(51) Int. Cl. A21D 13/00; A21D 10/00; B65B 25/22; A21D 8/00; A23L 1/01

(52) U.S. Cl. 426/19; 426/551; 426/559; 426/107; 426/234

(57) ABSTRACT

An improved dough composition is provided which comprises fat chips and wheat protein isolate, wherein the dough composition can be used to prepare a frozen microwaveable bread product. The frozen microwaveable bread product can be heated in a microwave oven to provide a cooked bread product having a desirable dual texture where the outer layer of the bread product is crispy and the remainder of the bread product has a soft, airy texture. Methods of preparing the same are also provided.

### RELATED APPLICATIONS

This application claims the benefit of U.S. Provisional Application Ser. Nos. 61/094,957 and 61/094,955, filed Sep. 7, 2008, which are hereby incorporated by reference in their entireties.

### FIELD OF THE INVENTION

This disclosure relates to an improved dough and microwaveable frozen bread products prepared using the improved dough. More particularly, this disclosure relates to improved dough for making microwaveable frozen bread products having a dual texture after microwaving and a method for making the same. The improved dough is especially useful for preparing a fully baked or par baked flatbread type bread product with various toppings which can then be prepared in a microwave oven from the frozen state.

### BACKGROUND

Convenience foods (i.e., products which require a minimum amount of consumer preparation and are quick to prepare) are in high demand to accommodate today's busy lifestyles. Examples range from cheese and cracker snacks and refrigerated bagels to frozen dinners. Typically, such products will be eaten as packaged or after a brief heating period, preferably by microwave heating.

Baked bread products are normally available as freshly prepared products that are intended to be consumed within a relatively short time period or as frozen products which can be stored in the frozen state for relatively long periods of time and then thawed for consumption. Examples of such frozen bread products include frozen pizzas and flatbreads which are then heated in a conventional or microwave oven. Attempts to prepare microwaveable, conventionally-sized frozen bread products having toppings have generally not been successful. Consumers often complain that frozen pizza or flatbread products do not have the desired crispy crust. Moreover, microwave heating is generally uneven and, therefore, promotes the rapid onset of toughness of the cereal products, which is often perceived as staleness. Frozen bread products having toppings often absorb some of the water content of the toppings during heating, thus resulting in the cooked bread product having less than the desired amount of crispiness. Such problems from heating such frozen food products in a microwave oven may be due to inadequate moisture control during microwave heating. Frozen bread products generally are pre-baked or par-baked and use susceptors embedded in the packaging of the microwaveable product. Microwaveable bread or other cereal-based products present a variety of technical hurdles that are difficult to overcome. For example, in microwave cooking of frozen flatbread or pizza products, it is often difficult to obtain the crispy and brown bottom crust desired by consumers. Even the use of susceptors can lead to uneven heating and/or uneven crisping of frozen pizza crusts and flatbreads.

Today's standards for microwaveable bread products, such as pizza crusts, flatbreads, and other thin breads, are high. The marketplace desires, if not expects, microwaveable bread products that rival artisan bread products made in a conventional or masonry oven in both texture and taste. Flatbread products made in a conventional or masonry oven generally have a crispy outer layer while the remainder of the product has an airy and soft texture. Such a dual textured flatbread product is considered highly desirable by consumers. Frozen flatbread products are rising in popularity and are available with a variety of toppings but do not have the dual texture desired by consumers.

Thus, there remains a need for frozen bread products which can be cooked in a microwave oven to provide a bread product having a crispy bottom surface while the remainder of the bread product has a soft, airy texture.

This disclosure provides a dough composition which provides a baked bread product that, upon heating in a microwave or conventional oven, has a crispy bottom surface with artisan-like brown spots, while the remainder of the bread product is airy and soft in texture. These and other advantages will be apparent upon consideration of the present specification.

### SUMMARY

This disclosure relates to fully baked or par baked microwaveable frozen bread products which, when heated in a microwave oven, have a desirable dual texture (i.e., a crispy bottom surface while the remainder of the bread product is airy and soft in texture). Although the use of microwave heating is preferred, the present frozen bread products can also be heated in a conventional oven and still generate the desirable dual texture. Generally the bread products of the present invention are generally of the flatbread type and can be prepared with or without toppings. The crispy bottom surface of the cooked bread product has brown spots and general appearance reminiscent of artisan breads.

Preferably, the frozen bread product described herein is heated in a microwave oven using a tray including a susceptor having a configuration which permits folding of the bread product after microwaving to provide a flatbread-type sandwich without significant cracking or breaking along the fold line of the bread product. Although bread products which can be folded after microwaving are preferred, bread products without this property can be used in the present invention. Preferably the frozen bread product will have one or more toppings on the upper exterior surface of the bread product. The toppings can be, and preferably are, placed on the upper exterior surface during manufacture and are frozen in place on the bread product so that the consumer can simply open the package, place it in a microwave oven with a suitable susceptor, and prepare the final product without additional steps. The frozen bread product can also be supplied without toppings; consumers can then prepare the bread product with or without toppings as they desire. For purposes herein, “bread” product, “flatbread-type bread” products, or bread products of the “flatbread type” refer to fully-baked or par-baked relatively thin bread products (typical thickness of less than about 2 inches) such as, for example, flatbread, pizza crust, pita bread, naan, and the like.

For purposes herein, “bottom surface” or “bottom exterior surface” refers to the surface of the bread product which is in contact with a susceptor when cooked in a microwave or with a baking rack when cooked in a conventional oven. Likewise, the “top surface” or “top exterior surface” is opposite the bottom surface and can receive the desired topping or toppings. And the “interior portion” refers to the bread product between the top and bottom surfaces.

The bread product provided herein includes a unique dough formulation that provides a bread product, preferably a flatbread product or pizza crust, having a crispy bottom surface while the remainder of the bread product has a soft and airy texture upon cooking in a microwave or conventional oven.

It has surprisingly been discovered that a yeast and/or chemically-leavened dough comprising wheat protein isolate and fat chips can be used to provide a frozen baked bread product that, after cooking in a microwave or conventional oven, has a crispy bottom surface while the remainder of the bread product has a softer and airier texture as compared to otherwise similar bread products prepared from leavened dough not including wheat protein isolate and fat chips. It is believed that the fat chips melt during the initial baking, thus leaving voids or holes which are then filled by carbon dioxide produced by the leavening agent. While not wishing to be limited by theory, it is believed that the wheat protein isolate provides a softer dough which allows the generated carbon dioxide gas to expand the dough, including the voids produced by the melted fat, during the initial baking while also providing sufficient strength to the dough such that the dough is able to maintain the porous structure formed by the gas bubbles, thus forming a light, airy, soft texture to the bread product.

Moreover, the crispy, but not hard or tough, bottom surface of the baked bread product develops brown spots reminiscent of artisan-type bread products that are appealing and desirable to consumers upon cooking in a microwave or conventional oven. Again, not wishing to be limited by theory, it appears that these desirable brown spots are formed over voids or holes generated near the bottom surface due to the thinness of the dough covering such voids or holes.

Suitable leavening agents include yeast (e.g., dry yeast, compressed yeast), encapsulated chemical leavening agent (e.g., encapsulated sodium bicarbonate, encapsulated ammonium bicarbonate, encapsulated calcium bicarbonate), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone), mixtures thereof, and the like. Other organic acids suitable for baking may also be used, such as fumaric acid, lactic acid, tartaric acid, malic acid, citric acid, and the like. Preferably, a combination of compressed yeast, encapsulated sodium bicarbonate, and sodium aluminum phosphate is used as the leavening agent. Surprisingly, it was found that using both compressed yeast and encapsulated chemical leavening agent provided a bread product, which upon baking in a microwave or conventional oven, has an especially crispy bottom layer than a similar bread product where only the compressed yeast or encapsulated chemical leavening agent were used alone.

Fat chips (i.e., shortening flakes) used in the present invention can be regularly shaped particles or irregularly shaped particles. Many factors are involved in successfully selecting and incorporating fat chips into the dough formulation, including the size of the fat chips, the solid fat content of the fat chips, the temperature of the dough, the mixing speed and time used to incorporate the fat chips into the dough, and the like. Fat chips suitable for use herein are relatively hard solids at 80° F. (i.e., have a minimum solid fat content of about 50 percent at 80° F.). Fat chips in the form of hard solids at 80° F. generally provide bread products having an airier and softer texture than bread products made with softer fat chips (i.e., have a solid fat content of less than about 50 percent at 80° F.). The size of the fat chips added to the dough mixture is less important than the size of the chips after mixing of the dough and prior to baking the dough. Preferably, the fat chip particles after mixing and prior to baking generally range between about 5 mg to about 45 mg but have an average weight of about 25 to 35 mg; assuming a spherical shape, this corresponds to effective diameters ranging between about 0.5 to 50 mm and an average effective diameter of about 3 to about 5 mm. “Effective diameters” are calculated values using the spherical shape assumption. Preferably the average effective diameter is in the range of about 2 to 10 mm and more preferably about 3 to 5 mm. Larger fat chips may be used so long as the size of the fat chips is reduced during mixing or the fat chips distributed within the dough are of a size that allows the formation of voids upon melting of the fat chips which provide the light and airy texture within the fully baked or par baked bread products of this invention. The solid fat content of the fat chips also affects how easily the chips are damaged during mixing (e.g., lose their “chip” shape, melt, flake off, break up, disintegrate, or the like). Generally, fat chips having lower solid fat content are more delicate and require lower mixing speeds, shorter mixing times, and/or lower dough temperatures during mixing to reduce damage to and/or melting of the fat chips. Therefore, the mixing speed, the mixing time, and/or dough temperature during mixing should be selected in view of the solid fat content of the fat chips and the starting size of the fat chips and in view of the target size of the fat chips after mixing and before baking. For example, if the particular fat chips selected are of the size desired after mixing, the dough temperature can be selected so as to prevent melting of the fat chips during mixing and/or the mixing speed and time can be selected so as to substantially reduce the amount of damage caused to the fat chips. Alternatively, if the particular fat chips selected are larger than the size desired after mixing, more intense mixing conditions and/or higher temperatures of the dough may be necessary to break-up and reduce the size of the fat chips. Fat chips that are too small do not provide adequate voids in the dough upon melting during baking and, therefore, the resulting bread product is dense and does not have the desired airy texture.

As those skilled in the art will realize, the initial size of the fat chip particles, hardness of the fat chips, mixing conditions, and similar parameters can be adjusted to provide the desired fat chip size, distribution, and the like which will provide the desired texture in the baked or par-baked product. Adjustment of such parameters can easily be carried out using appropriate experimental designs or methods using laboratory or pilot plant sized batches and then scaling up to manufacturing plant sized batches.

In an important aspect, the yeast and/or chemically-leavened dough described herein includes, in baker's percentages, about 0.05 to about 5 percent wheat protein isolate and about 0.5 to about 10 percent fat chips. Preferably, the dough described herein includes about 0.1 to about 0.3 percent wheat protein isolate and about 5 to about 9 percent fat chips.

The disclosure also includes methods for making the baked or par-baked bread products using this bread dough for later heating in microwave or conventional ovens. One such method comprises (a) mixing dough ingredients comprising, in baker's percentages, 100 percent flour, about 55 to about 70 percent water, about 0.5 to about 7 percent leavening agent, about 0.05 to about 5 percent wheat protein isolate, and about 0.5 to about 10 percent fat chips; (b) resting the dough, such as for about 5 to about 10 minutes; (c) shaping the dough to the desired size and shape; (d) proofing the dough, such as at about 80 to about 90° F. for about 24 to about 30 minutes at a relative humidity of about 50 to about 80 percent; and (e) baking the dough to form a baked or par-baked bread product. Of course, the conditions under which the fat chips are incorporated into the dough should be adjusted so that the appropriately sized fat chips are contained in the dough prior to the initial baking step. The baked or par-baked bread product may then be topped with one or more toppings, if desired, and frozen. Preferably, the wheat protein isolate, flour, leavening agent, water, and any optional ingredients are mixed together first and then the fat chips are incorporated therein; this allows more precise control over mixing conditions, and thus the particle size of the fat chips, within the dough as well as avoiding damage the fat chips. Mixing should be controlled so that the fat chips are of the desired weight or size in the dough and are distributed uniformly though the dough.

In one preferred form, the bread product is a microwaveable frozen flatbread that, when heated on a susceptor in a microwave oven, has a crispy bottom surface with artisan-like brown spots while the remainder of the bread product has an airy and soft texture. Generally, the brown spots have a somewhat harder texture than the remainder of the bottom surface. It is believed that the brown spots are thin areas of dough covering voids created from air bubbles close to or adjacent to the bottom surface. The thin areas of the bottom surface which cover the voids heat up faster than other areas of the bottom surface, thus causing those thin areas to darken faster and become more crispy.

In another preferred form, the bread product is a frozen pizza crust that can be baked in a microwave or conventional oven to provide an artisan-style pizza crust having a crispy bottom surface with artisan-like brown spots while the remainder of the pizza crust has an airy and soft texture. If the pizza crust is baked in a conventional oven and does not include toppings, the upper surface of the pizza crust will also become crispy while the interior portions (i.e., between the lower surface and the upper surface) will have a softer, airy texture.

If desired, the frozen bread product described herein may include a variety of toppings, such as, but not limited to, meat, cheeses, vegetables, tofu, soy, soy derivatives, sauces, dressings, spreads, gravies, condiments, spices, herbs, flavorings, colorants, and the like, as well as mixtures thereof.

In one aspect, a package contains the fully assembled bread product preferably includes one or more microwave susceptors to assist in the microwave heating; in such case, the opened package containing the fully assembled bread product and microwave susceptor(s) are directly placed in the microwave oven. Alternatively, separate microwave susceptors can be included in the package; in such case, the fully assembled frozen bread product is then placed on the susceptor and the combination placed in the microwave oven for heating. In a preferred form, a tray is provided comprising a susceptor surface, wherein the susceptor surface includes an area free of susceptor material in order to foam a fold zone. Heating the bread product on such a susceptor in a microwave oven provides a bread product having a crispy surface adjacent the susceptor surface but a non-crispy or less crispy surface adjacent the area free of susceptor material in the fold zone. Such an arrangement allows the bread product (e.g., flatbread) to be folded without significant cracking or damage to the fold zone of the bread product.

The invention is related to U.S. Patent Provisional Application Ser. No. 61/094,955, filed Sep. 7, 2008, which entitled “Tray For Microwave Cooking and Folding of a Food Product,” which is owned by the same assignee, and is hereby incorporated by reference herein in its entirety. The present specification is likewise incorporated by reference into the just named specification.

### BRIEF DESCRIPTION OF THE DRAWINGS

FIG. 1 provides a side view of a bread product having a topping coextensive with the upper bread surface. The bread product is provided on a tray having a susceptor surface thereon.

FIG. 2 provides a general flow chart illustrating a general method for the preparation of a fully assembled frozen flatbread product of the invention.

FIG. 3 provides a more detailed flow chart illustrating another method for preparing a flatbread or fully assembled flatbread product of the invention.

FIG. 4 is a top perspective view of an embodiment of a tray having an elevated food product support surface with a susceptor thereon;

FIG. 5 is a bottom perspective view of the tray of FIG. 4;

FIG. 6A is a top perspective view of the tray of FIG. 4 with a food product on the food product support surface;

FIG. 6B is a perspective view of the tray and food product of FIG. 6A being folded;

FIG. 6C is a perspective view of the tray and food product of FIG. 6A in a further folded position from that of FIG. 6B;

FIG. 6D is a perspective view of the tray and food product of FIG. 6A, showing the food product folded and the tray returned to its unfolded position;

FIG. 7 is a perspective view of another embodiment of a tray having an elevated food product support surface with a susceptor therein, and having handles extending outwardly from depending legs;

FIG. 8A is a partial perspective view of the tray of FIG. 7, showing one of the handles in an unextended position;

FIG. 8B is another partial perspective view of the tray of FIG. 7, showing one of the handles moving to an extended position;

FIG. 9A is a partial perspective view of tray of FIG. 4, showing detail of perforations for removal of a corner region;

FIG. 9B is another partial perspective view of the tray of FIG. 4, similar to that of FIG. 9A, but showing the tray after removal of the corner region; and

FIG. 9C is another partial perspective view of the tray of FIG. 4, similar to that of FIG. 6A, but showing a corner perforation being broken to permit folding of the tray.

FIG. 10 is a diagram of the template used to test the firmness of the inventive flatbread according to the Example.

FIG. 11 is a diagram of the template used to test the firmness of the Lean Cuisine® Flatbread Melt according to the Example.

FIG. 12 is a bar graph showing firmness measured via a TA-TX2 Texture Analyzer for inventive flatbreads made using dough incorporating fat chips and wheat protein isolate as compared to commercially available Lean Cuisine's® Flatbread Melts of the Example.

### DETAILED DESCRIPTION

This disclosure relates to improved dough and microwaveable frozen bread products, preferably a microwaveable flatbread product, although other thin bread products, including pizza crusts, pita bread, naan, and the like, are also contemplated. Such bread products, when heated in a microwave or conventional oven, have a crispy bottom surface while the remainder of the bread product has a soft, airy texture. The dual texture provided in the bread products described herein is very desirable to consumers and has not been achieved in microwaveable bread products prior to the invention described herein. If desired, the bread product may include toppings on the upper surface. This disclosure further relates to method of making the dough and microwaveable frozen bread products.

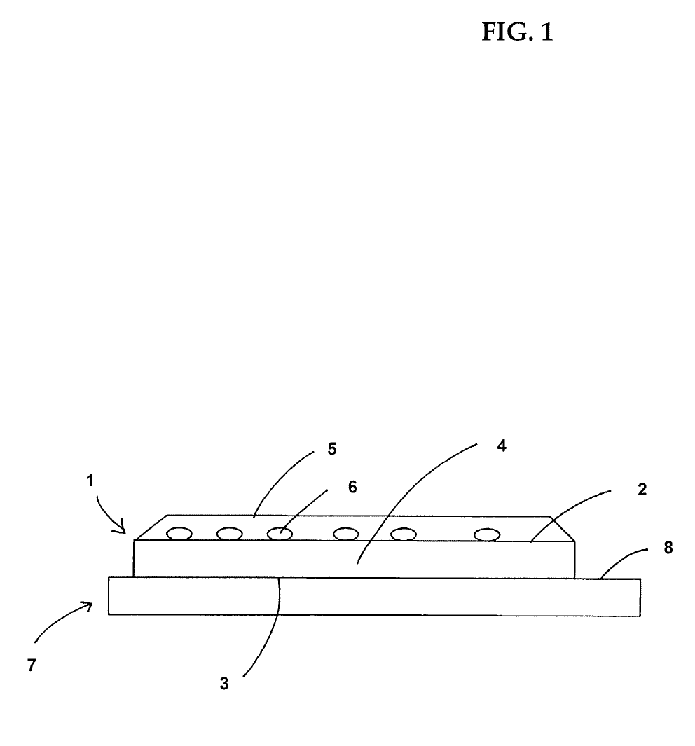

FIG. 1 illustrates a fully assembled frozen bread product 1 having an upper surface 2, a bottom surface 3, an interior portion 4, and topping 5. Topping 5 may be provided on the upper surface 2 of the bread product 1. In one aspect, the bread product 1 may include a topping 5, which may include, if desired, meat or vegetables in the form of chunks, lumps, or diced shapes 6. The topping may be substantially coextensive with the upper surface 2 (as illustrated) but is not required. In a preferred aspect, the bread product is cooked in a microwave oven on a tray 7 having a susceptor surface 8. The bottom surface 3 of the bread product 1 is in contact with the susceptor surface 8 during cooking. The bottom surface 3 becomes crispy during final heating and develops brown spots reminiscent of artisan breads.

Dough Formulation. The following descriptions refer to preparation and use of bread dough for purposes of the provided non-limiting illustrations, but it will be appreciated that the concepts of the disclosure are considered to be generally applicable to a variety of fully-baked or par-baked thin bread products, including flatbread, pizza crust, pita bread, naan, and the like. It will also be appreciated that, while the disclosure herein generally focuses on frozen microwaveable bread products, the frozen bread products described herein are also suitable for baking in conventional ovens to provide a dual textured bread product. Generally, bread products without toppings which are cooked in a conventional oven will have a crispy upper surface, as well as a crispy lower surface, and the area interior to the upper and lower surfaces will have a soft, airy texture, whereas the same untopped frozen bread product cooked in a microwave oven will generally not have a crispy upper surface without using a susceptor adjacent to that upper surface.

The bread dough described herein comprises a unique formulation which provides the desirable dual texture on the top and bottom surface and an airy internal texture or structure upon heating in a microwave or conventional oven. The bread dough comprises a leavened mixture comprising a major portion of flour and water and a minor portion of wheat protein isolate and fat chips. The bread dough may be yeast and/or chemically leavened. It has surprisingly been discovered that incorporation of wheat protein isolate and fat chips in yeast and/or chemically-leavened dough provides a bread product which, after cooking in a microwave or conventional oven, has a crispier bottom surface while the remainder of the bread product has a softer and airier texture as compared to otherwise similar baked products prepared from leavened dough without wheat protein isolate and fat chips. Moreover, the crispy, but not hard or tough, bottom surface is provided with brown spots reminiscent of artisan-type bread products.

It is believed that the fat chips melt during initial baking, thus leaving voids which can be filled, and expanded, by carbon dioxide gas produced by the leavening agent. The melted fat appears to be absorbed by the surrounding dough. While not wishing to be limited by theory, it is believed that the wheat protein isolate provides a softer dough that allows the carbon dioxide gas to expand the dough, as well as the voids produced from the melting fat, while also providing sufficient strength such that the dough is able to maintain the porous structure formed by the gas bubbles, thus forming the highly desirable light, airy, soft texture. During final heating in the microwave or oven, the susceptor in the microwave oven rapidly increases in temperature. Therefore, the areas of the bottom surface of the bread product in contact with the susceptor also become hot more rapidly. The thin areas of the bottom surface covering voids created by air bubbles heat up faster than other areas of the bottom surface, thus causing those thin areas to darken faster and become crispier than surrounding areas, thus forming the brown spots.

The dough comprises, in baker's percentages, about 0.5 to about 10 percent fat chips and about 0.05 to about 5 percent wheat protein isolate. Preferably, the dough comprises, in baker's percentages, about 5 to about 9 percent fat chips and about 0.1 to about 0.3 wheat protein isolate.

An illustrative and preferred recipe (in baker's percentages) for dough prepared according to an embodiment of the invention is provided in the table below.

| | Illustrative Recipe | Preferred Recipe |
|---|---|---|
| Ingredient | (% flour basis) | (% flour basis) |
| Flour | 100 | 100 |
| Compressed yeast | 0.5-5 | 2-3 |
| Encapsulated chemical | 0-2 | 0.1-0.5 |
| leavening agent | | |
| Leavening acid | 0-1 | 0.1-0.5 |
| Salt | 0-4 | 1-3 |
| Sweetener | 0.5-6 | 0.5-1.5 |
| Wheat protein isolate | 0.05-5 | 0.1-0.3 |
| Fat chips | 0.5-10 | 5-9 |
| Vital wheat gluten | 0-8 | 1-3 |
| Water | 55-70 | 58-60 |
| Oil | 0-8 | 3-5 |

Suitable leavening agents include yeast (e.g., dry yeast, compressed yeast), encapsulated chemical leavening agent (e.g., encapsulated sodium bicarbonate, encapsulated ammonium bicarbonate, encapsulated calcium bicarbonate), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone), mixtures thereof, and the like. Other organics acids suitable for baking may also be used, such as fumaric acid, lactic acid, tartaric acid, malic acid, citric acid, and the like. Preferably, a combination of compressed yeast, encapsulated chemical leavening agent, and leavening acid is used. More preferably, compressed yeast, encapsulated sodium bicarbonate, and sodium aluminum phosphate are used as the leavening agent. It was surprisingly found that using a leavening agent comprising compressed yeast, encapsulated chemical leavening agent, and acid leavening agent provided a bread product, which upon baking in a microwave or conventional oven, has a crispier outer layer than a similar bread product where either the compressed yeast or encapsulated chemical leavening agent (with leavening acid) was used without the other. Generally, a bread product made with compressed yeast but without chemical leavening agent provides a slightly denser product. Generally, about 0.5 to about 5 percent compressed yeast is used, preferably about 2 to about 3 percent compressed yeast. When the leavening agent comprises yeast, encapsulated chemical leavening agent, and leavening acid, about 0.5 to about 5 percent compressed yeast, about 0 to about 2 percent chemical leavening agent, and about 0 to about 1 percent leavening acid are used; preferably about 2 to about 3 percent compressed yeast, about 0.1 to about 0.5 percent chemical leavening agent, and about 0.1 to about 0.5 percent leavening acid are used. Dry yeast may be substituted for the compressed yeast. If dry yeast is used, the baker's percentage or weight is adjusted to account for the water content of the compressed yeast; likewise, the amount of water added may be increased to account for the water content of the compressed yeast.

Fat chips (i.e., shortening flakes) are generally regularly shaped or irregularly shaped particles; the actual shape of these fat chips or flakes does not appear to be especially important so long as suitable sized voids are produced in the dough after the fat chips or flakes melt. Many factors are involved in successfully incorporating fat chips into the dough formulation, including the size of the fat chips, the solid fat content of the fat chips, the temperature of the dough, the mixing speed, and mixing time. Fat chips suitable for use herein are generally hard solids at 80° F. (i.e., have a minimum solid fat content of about 45 percent at 80° F. and preferably 50 percent at 80° F.). Fat chips which are hard solids at 80° F. provide bread products having an airier and softer texture than bread products made with fat chips that are softer (i.e., have a solid fat content of less than about 40 percent at 80° F.). The initial size of the fat chips added to the dough mixture is less important than the size of the chips after mixing of the dough and prior to baking the dough. Preferably, the fat chips after mixing and prior to baking generally range between about 5 mg to about 45 mg but have an average weight of about 30 mg. The solid fat content or firmness of the fat chips will affects how easily the chips are reduced in size or are damaged during mixing (e.g., lose their “chip” shape, melt, flake off, break up, disintegrate, or the like). Generally, fat chips having lower solid fat content are more delicate and may require more gentle mixing conditions (i.e., lower mixing speeds, shorter mixing times, and/or lower dough temperatures) during mixing to reduce damage to and/or melting of the fat chips. Therefore, the mixing speed, the mixing time, and/or dough temperature during mixing should be selected in view of the solid fat content of the fat chips and the starting size of the fat chips and in view of the target size of the fat chips after mixing and before baking. For example, if the particular fat chips selected are of the size desired after mixing, the dough temperature can be selected so as to prevent melting of the fat chips during mixing and/or the mixing speed and time can be selected so as to substantially reduce the amount of damage caused to the fat chips. Alternatively, if the particular fat chips selected are larger than the size desired after mixing, faster mixing speeds and/or higher temperatures of the dough may be used to reduce the size of the fat chips to the desired range. Fat chips that are too small do not provide adequate voids in the dough upon melting during baking and, therefore, the resulting bread product is dense and does not have the desired airy texture. As noted above, initial size and firmness of the fat chips and the mixing conditions can be adjusted to provide a dough having properly sized fat chips uniformly distributed within the dough, which can then be baked or pare baked to provide a bread product with dual texture on the top and bottom surfaces and an airy texture internally.

Wheat protein isolate is prepared by removing starch from wheat flour. While not wishing to be limited by theory, it is believed that the wheat protein isolate provides a soft dough which allows the carbon dioxide gas to expand the dough while also providing sufficient strength to the dough such that the dough is able to maintain the porous structure formed by the gas, thus forming a light, airy, soft texture to the bread product. Suitable commercial wheat protein isolate products include, for example, Arise 5000 from MGP Ingredients, Inc. and Prolite 100 from ADM. Arise 5000 includes about 90 percent wheat protein. Bread products prepared without wheat protein isolate are generally very dense and do not have the desired soft, airy texture.

Exemplary of the flour component or farinaceous materials which may be used, for example, are whole grain or refined wheat flour. Hard or soft wheat flours, red or white wheat flours, winter or spring, and blends thereof, all purpose flours, and so forth may be used. The flour may be bleached or unbleached. Wheat flour or mixtures of wheat flour with other grain flours are preferred. For pizza crust applications, high gluten flours are particularly desirable. High gluten flours include, for example, flours made from milled hard wheat grain (e.g., hard red winter wheat, hard white wheat, and hard white spring wheat), or spelt. Vital wheat gluten or other wheat protein fractions, including those of gliadin or glutenin, may be added to the flours as a protein source or functional agent. For example, lower gluten content flours, such as triticale, can be used with vital wheat gluten added to increase gluten content.

The bread dough also may contain minor amounts of other functional and flavoring additives commonly used in bread dough, such as oil, protein source, sweetener, preservative, emulsifier, salt, dough conditioners, chemical leavening agent, herbs, seasonings, spices, and the like, as long as the additional ingredients do not adversely affect formation of the dual textured product with the light, airy interior. If desired, the dough can be fortified with macronutrients and/or micronutrients, such as iron preparations, bioavailable calcium sources, vitamins, minerals, amino acids, and other nutraceuticals. Vitamin and vitamin-like nutritional fortification can be obtained using Vitamin C, Vitamin E sources, Vitamin D sources, beta carotene sources, and so forth. Vitamin C also may be used as a functional additive in a conventional manner for gluten strengthening, and other performance quality enhancements and benefits.

Suitable oils include vegetable oils, shortening, hydrogenated oil, and the like. Preferred vegetable oils are corn, canola, sunflower seed, cottonseed and soybean oils, or mixtures thereof, with soybean oil and corn oil being the most preferred. The oil may have a butter flavoring agent. Fat substitutes may also be used, if desired. Alternatively, a butter flavoring agent or other flavoring agent may be added to the recipe in an amount known to those skilled in the art or in accordance with the flavor manufacturer's recommendations.

The dough also may include sweeteners. These include sugars such as sucrose, fructose, glucose, high fructose corn syrup, or other sweet mono- or disaccharides commonly used in baking materials. The total sugar solids content of the dough of the present invention may range from 0.5 up to about 6 percent by weight, depending on the product. For bread dough, the total sugar content generally may range between 0.5 to about 6 percent by weight, particularly between about 0.5 to about 1.5 percent. All or a portion of the natural sweetener content can be substituted by or augmented with artificial sweetener, nonnutritive sweetener, high intensity sweetener, sugar alcohol materials, and the like. Of course, if used, the levels of such other sweeteners should be adjusted to provide the desired level of sweetness and, if appropriate (i.e., if corn syrup is used), the level of water may be adjusted to account for water added with the sweetener.

If desired, emulsifiers may be included in effective, emulsifying amounts in the dough of the disclosure. Exemplary emulsifiers which may be used include, mono- and di-glycerides, polyoxyethylene sorbitan fatty acid esters, DATEM (di-acetyl tartaric acid esters of mono- and diglycerides), lecithin, stearoyl lactylates, and mixtures thereof. Exemplary of the polyoxyethylene sorbitan fatty acid esters which may be used are water-soluble polysorbates such as polyoxyethylene (20) sorbitan monostearate (polysorbate 60), polyoxyethylene (20) sorbitan monooleate (polysorbate 80), and mixtures thereof. Examples of natural lecithins which may be used include those derived from plants such as soybean, rapeseed, sunflower, or corn, and those derived from animal sources such as egg yolk. Soybean-oil-derived lecithins are preferred. Exemplary of the stearoyl lactylates are alkali and alkaline-earth stearoyl lactylates such as sodium stearoyl lactylate, calcium stearoyl lactylate, and mixtures thereof. Exemplary amounts of the emulsifier which may be used range up to about 3 percent by weight of the dough.

Since the baked or par baked bread of this invention will generally be distributed in a frozen form, preservatives may not be required. Nevertheless, the dough of the disclosure may include antimycotics or preservatives, such as calcium propionate, potassium sorbate, sorbic acid, sodium benzoate, nisin, and the like, singly or in combinations thereof, if desired. Exemplary amounts may range up to about 1 percent by weight of the dough, to assure microbial shelf-stability.

Flavorings and/or spices may be used in the manufacture of the flatbread dough, if desired. The flavorings may include, for example, olive oil, rosemary, garlic, butter, salt and the like. Other flavorings or combinations of flavorings may be used, if desired.

The bread formulations of this disclosure are designed to provide good organoleptic properties and a crisp bottom layer while the remainder of the bread product has a soft, airy texture after microwaving or baking in a conventional oven by the consumer. Thus, the bread formulations provided herein have better organoleptic properties as compared to similar microwaveable products prepared with conventional dough formulations, including conventional dough formulations used in microwaveable products currently available in the marketplace. Although the dough formulations described herein are especially designed for use in flatbread food products, the dough formulations can be used to advantage in other bread products, including those intended to be heated in microwave ovens and conventional ovens, such as pizza crust, pita bread, naan, and the like.

Dough Mixing and Dough Products. The dough formulations of the disclosure can be formed into a useful bread product using a variety of techniques. The dough is mixed, rested, shaped, proofed, and baked before freezing. The bread product may be topped before or after freezing, if desired. The sequence of the other operations is not particularly limited and may be varied. It is important, as noted above, that the initial size and hardness of the fat chips, as well as the conditions under which they are incorporated into the dough, be adjusted to obtain the desired size and homogenous distribution of the fat chips in the dough before baking so that the desired textural characteristics are obtained.

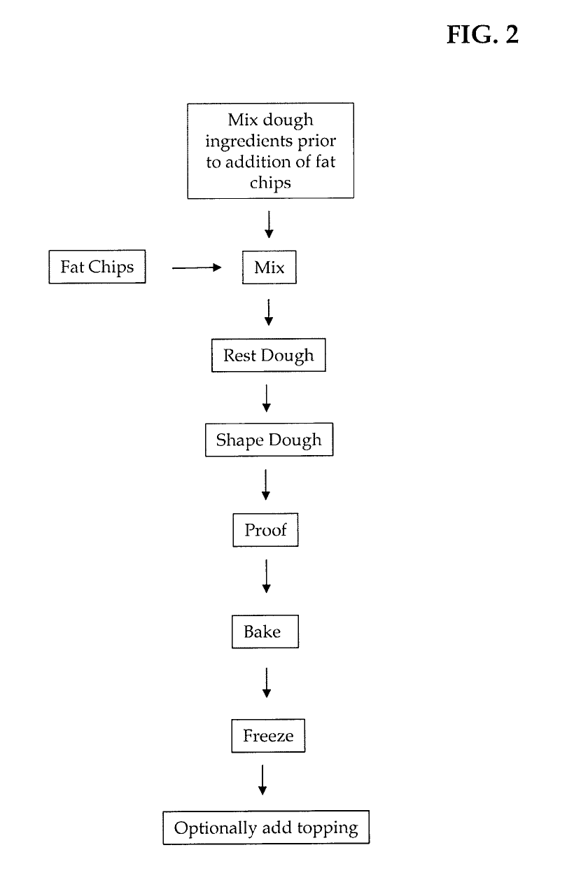

FIG. 2 illustrates a preferred general method of preparing fully assembled frozen bread products of the disclosure. As those skilled in the art will recognize, the order of steps shown in FIG. 2 can be modified if desired; for example, freezing can occur before or after adding a topping. The dough is first prepared by mixing dough ingredients comprising, in baker's percentages, 100 percent flour, about 55 to about 70 percent water, about 0.5 to about 7 percent leavening agent, about 0.05 to about 5 percent wheat protein isolate, and about 0.5 to about 10 percent fat chips. Other ingredients may be added if desired. Preferably, the dough ingredients are first mixed before adding the fat chips. Then the fat chips are added and mixed under conditions to provide the desired size and distribution of the fat chips in the dough. The mixing speed, the mixing time, and/or dough temperature during mixing should be selected in view of the solid fat content of the fat chips and the starting size of the fat chips to achieve the desired size and distribution of the fat chips after mixing and before baking. For example, if the particular fat chips selected are close to the size desired after mixing, the dough temperature can be selected so as to prevent melting of the fat chips during mixing and/or the mixing speed and time can be selected so as not to substantially reduce the size of the fat chips or otherwise damage them. Alternatively, if the particular fat chips selected are larger than the size desired after mixing, mixing conditions can be modified to achieve the desired size and distribution of the fat chips in the dough prior to baking.

The resulting dough mixture is rested for about 5 to about 10 minutes and then shaped to the desired size and shape. The dough is the proofed the dough, such as at about 80 to about 90° F. for about 24 to about 30 minutes at a relative humidity of about 50 to about 80 percent. The proofed dough is then baked to form a baked or par-baked bread product. The bread product may then be topped with one or more toppings, if desired. The bread product and any toppings that have been added are then frozen.

Preferably, the wheat protein isolate, flour, leavening agent, water, and any optional ingredients are mixed prior to the addition of the fat chips in order to allow better control of the size and distribution of the fat chips in the dough. If desired, the process may include an optional pressing step with or without heat to better shape the dough. The dough is then baked. As noted above, the fat chips will melt to form voids or holes within the dough which can then be expanded by the generated gas during baking. Of course, some melting of the fat chips adjacent to the external surfaces may occur during the optional pressing stage (if heat is used); such early melting (if it does occur) appears to allow the desired formation of the voids or holes in the baked product.

As those skilled in the art will realize, the baking conditions will largely depend on the type of oven used and the size/weight of the dough. For example, a dough piece (about 85 to 91 grams) in the shape of a square or circular could be baked in an impingement-type oven at about 550 to about 650° F. for about 1 to about 2 minutes. As one of ordinary skill in the art will readily recognize, the precise baking temperatures and baking time will vary depending on the type of oven used and the type of bread product being made.

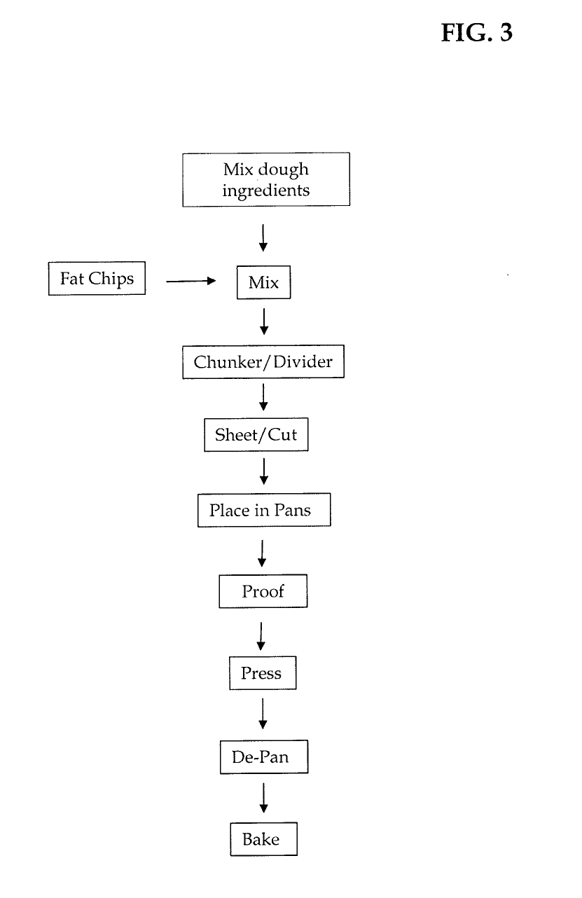

FIG. 3 provides a detailed flow chart illustrating methods of preparing dough products comprising fat chips and wheat protein isolate. As those skilled in the art will realize, the various steps of the process shown in FIG. 3 (as well as the more general process shown in FIG. 2) can be modified, re-ordered, eliminated, and/or incorporated into one or more of the other processes described, depending on the type of bread product being made, the equipment available, desired optional steps, and other considerations in the baking industry. The dough is first prepared by dry blending flour, leavening agent, wheat protein isolate, and water. Optional ingredients may be added, if desired. The dough mixture is mixed, such as on high speed for about 6 minutes or until the dough has developed viscoelasticity. The fat chips are then added and mixed into the dough to form a homogenous distribution of properly sized fat chips. The dough mixture is then subjected to a chunker/divider to obtain the desired amount of dough. The dough is then formed into an appropriate sheet by extrusion, such as into dough pieces of about 3.17 to about 3.87 ounces, and cut into the desired shape and size. The cut dough is then placed in individual pans of the appropriate size and shape and then proofed (about 80 to about 90° F. for about 24 to about 30 minutes at a relative humidity of about 50 to about 80 percent) to allow the dough to relax prior to molding. The dough compositions can be optionally treated with presses to form the shape, such as about 5 to about 10 seconds. The pressed dough products are then depanned and baked. For example, a dough piece (about 85 to 91 grams) in the shape of a square or circle could be baked in an impingement-type oven at about 550 to about 650° F. for about 1 to about 2 minutes. The baked crusts are frozen before or after adding a topping (if used). If a topping is added to the frozen crusts, the resulting product should then be frozen as a unit.

Bread products of conventional and non-conventional shapes can be formed. Such conventional shapes include, for example, a generally circular, oval square, rectangular (rectangular with one or more rounded ends), and the like, although other shapes may be prepared, if desired. Although the dimensions can vary, the bread product generally has a thickness of about ⅙ inch to about 2 inches thick depending on the actual intended use; preferably the thickness is less that about 1 inch and more preferably less than about ¾ of a inch. For pizza crusts, the baked crust is preferably about 1/16 inch to about ½ inch thick. For flatbreads, the baked flatbread is preferably about ⅛ inch to about ½ inch thick.

The raw dough may be directly used in baking operations or, alternatively, it may be stored under refrigerated or frozen conditions as a chilled product until used later. The dough may be topped to provide a composite dough product that can be subsequently baked. Depending on the product, the dough may be pre-shaped, baked or par-baked, and topped. The bread product and/or topped bread product may be packaged in any suitable conventional manner for storage and handling.

Preferably, the bread product is frozen after baking. The bread products described herein may be frozen for long term storage. Such bread products are stable at freezing temperatures for at least about 4 months, preferably at least about 12 months.

If desired, the bread product may be provided with one or more toppings thereon. Generally, the topping is placed on the top of the flatbread using any suitable automatic, semiautomatic, or manual technique. Suitable toppings include, for example, meats (e.g., chicken, turkey, beef, ham, and the like), cheeses, vegetables, tofu, soy, soy derivatives, and the like as well as combinations thereof. Such toppings may also include sauces, dressings, spreads, gravies, condiments, spices, flavorings, colorants, and the like as well as combinations thereof. Preferably, meat and/or vegetables in the topping are in the form of lumps or diced shapes (generally less than about 2 inches in the longest dimension).

The meat may be in a shaved, sliced, shredded, chopped, or other convenient form. The type of meat that may be used is not particularly limited. The meat may be beef (e.g., roast beef, barbecued beef, steak, hamburger, etc.); poultry (e.g., chicken breast, barbecued chicken, turkey breast, turkey burger, chicken salad, etc.); pork (e.g., ham, barbecued pork, ham salad, etc.); and fish (e.g., tuna, tuna salad, lox, etc.). The meat topping also may be processed meats like bacon, sausage, bologna, olive loaf, pepperoni, salami, corned beef, pastrami, liverwurst, and so forth. Combinations of such meat products may be used if desired. Soy or soy derivative meat substitutes may be used as a protein source in combination with the meat filling, or alternatively in place thereof in the sandwich filling. The water content and water activity of the meat topping may vary greatly depending on the type of meat selected. For instance, leaner cuts of meat generally contain less water content than less lean cuts.

The type of cheese that may be used is not particularly limited. The cheese may be in form of shredded, sliced, shaved, flaked, powdered, crumbled, slabbed, creamed, and so forth; preferably, the cheese is in the form of cheese shreds. The cheese type, for example, may be process cheese, cheddar cheese, Swiss cheese, American cheese, Provolone cheese, mozzarella cheese, Parmesan cheese, blue cheese, Monterey Jack cheese, Romano cheese, cream cheese, Havarti cheese, Gouda cheese, Muenster cheese, Asiago cheese, feta cheese, Gorgonzola cheese, and combinations thereof. Of course, other cheeses may be used if desired.

Vegetables suitable for use in the filling include, for example, onions, tomato, peppers, garlic, bean sprouts, cucumber, zucchini, potato, kale, basil, and the like as well as combinations thereof. Of course, other vegetables may be used if desired.

Both the bread portion and the topping can be seasoned, such as with salt, pepper, oregano, hot pepper flakes or spreads, onion powder, garlic powder, sesame seeds, poppy seeds, cinnamon, and the like as well as combinations thereof. Food additives, such as preservatives, flavorings, colors, emulsifiers, soy flour, and so forth, also can be included in or applied to the dough and/or topping.

All or some of the ingredients in the topping may be premixed if desired; alternatively, all or some of the ingredients may be individually placed on the bread product. All or some of the ingredients in the topping may be frozen or thawed when placed on the bread product. Indeed the entire topping may be prepared and then frozen into the appropriate size and shape (i.e., puck or other shape) and then placed frozen on the bread product. The bread product may also be pre-frozen. The bread product may be frozen before or after the addition of toppings, if used. Conventional freezing techniques are used to freeze the bread product.

The assembled bread product is packaged, preferably using modified atmosphere techniques, frozen (if not already frozen), and then stored under suitable conditions. Susceptors, if used, may be included in the same package as the assembled bread product or may be separately contained in the kit. In one aspect, the bread product is provided as a fully assembled flatbread with toppings thereon and contained in a package that can be opened and then heated directly in a microwave oven or conventional oven.

Alternatively, the frozen bread product and toppings can be provided in a single serve package having separate compartments or pouches for the frozen bread product and various toppings. The pouches preferably are sealed under an inert atmosphere to increase the shelf life of the product or kit.

Frozen bread products may be cooked in a microwave oven or conventional oven. Generally, the bread products can be microwaved from the frozen state (without thawing) for about 2 minutes, 45 seconds at full power on a susceptor in an 1100 watt microwave or in a conventional oven for about 13 to 15 minutes at about 400 to about 450° F. if the product is topped or for about 10 minutes if untopped. As one of ordinary skill in the art will readily recognize, the precise cooking conditions will vary depending on the type of oven used and the type of bread product being made.

As noted, the package containing the bread product preferably includes one or more microwave susceptors to assist in the microwave heating; in such case, the opened package containing the fully assembled food product and microwave susceptor(s) are directly placed in the microwave oven. Alternatively, separate microwave susceptors can be included in the package; in such case, the bread product is then placed on the susceptor and the combination placed in the microwave oven for heating. Preferably, the frozen bread product is supplied with an appropriately sized and shaped susceptor to assist in the microwave heating process. Various types and forms of susceptors are known in the art and can be provided for use with the bread products described herein. For example, the susceptor may be a film having a layer of metal deposited thereon. In addition, the susceptor may have different thicknesses to assist in concentrating heat energy at select portions of the fully assembled food product. The susceptor may be an integral part of the packaging of the frozen bread product or may be a separate component upon which the frozen bread product is placed before microwave heating.

Particularly preferred susceptors are described in greater detail herein. The use of the microwave susceptors described herein provides a bread product having a crispy outer layer while the remainder of the bread product has a soft, airy texture. During microwave heating, the susceptor positioned on the tray assists in regulating the moisture content of the flatbread such that the bottom surface has less moisture than the soft, airy center.

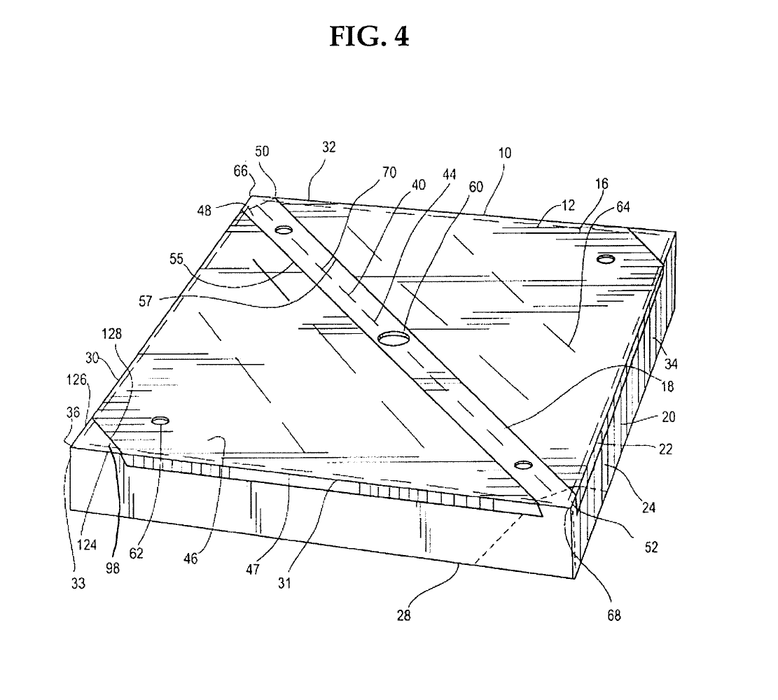

Raised platforms having susceptor material for micro-wave cooking of a foldable food product and methods of use are described herein and illustrated in FIGS. 4-10. The raised platform has legs that extend to elevate a food product support surface having the susceptor material, and thus the food product, above the floor of the microwave during the cooking cycle to provide more even microwave cooking. The susceptor material is disposed on the raised platform in a configuration facilitating folding of the cooked food product with reduced cracking or breaking.

The raised platform 10 has a food product surface 12 for supporting a food product 14 at least partially on a susceptor surface 16. The susceptor surface 16 provides for conductive heating of portions of the bread product 14 in contact therewith. After cooking, the surface 12 may be folded about a fold region 18 which is free from susceptor material. A fold zone of the food product immediately adjacent to the fold region 18 of the food product surface 12 does not experience the same degree of conductive heating and thus is more flexible. This facilitates folding of the bread product about the fold zone with the end result being less cracking or breaking of the food product in the fold zone.

The food product surface 12 includes depending legs 20 to support the food product surface 12 in an elevated position, such as above the floor of a microwave oven. The legs 20 depend from a periphery 22 of the food product surface, as illustrated in FIG. 4. The legs 20 may be a series of segments that form a continuous sidewall 24 that extending partially or completely around the periphery 22 of the food product surface. In the illustrated example of a generally rectangular food product surface 12 having outer periphery edges 47, a first segment 28 may extend and connect to an adjacent second segment 30 which connects to an adjacent third segment 32 which connects to an adjacent fourth segment 34 to form the sidewall 24. Each segment has a longitudinal edge 31 connected to the food product support surface and a pair of transverse edges 33, each of which is attached to the adjacent segment to form a corner 36.

The food product surface 12 includes areas of susceptor material 46 on both sides of an area free of susceptor material 48. The area free of susceptor material 48 coincides with the fold region 18 which bisects the food product surface 12. The fold region 18 may extend from an edge 50 to an opposite edge 52 of the food product surface 12. In the example of FIG. 4, the fold region 18 extends from a corner region 66 to an opposite corner region 68 along a diagonal 70 of the food product surface 12. The fold region 18 includes a fold line or area, preferably but not necessarily weakened line 40, extending parallel to an outer edge 55 and opposite outer edge 57 of the fold region 18 and at least along a substantial length of the fold region 18 sufficient to facilitate folding. The weakened line 40 may extend within the fold region 18 in the area free from susceptor material 48 at a location spaced an equal distance away on both sides from the area containing susceptor material 46. By free of susceptor material, what is meant is that this region will have less conductive heating than the adjacent portions having the susceptor material 46. This includes a region entirely free of susceptor material, as well as a region that has less than the adjacent susceptor material 46. The objective is to crisp the fold zone of the food product to a lesser degree than the adjacent portions of the food product. The weakened line 40 may include perforations 44, or creases, scores or other areas of weakness that facilitate the folding of the food product surface 12 about the fold region 18. The fold region of the food product surface may alternatively include at least two weakened lines that extend parallel to one another and extend the length of the fold region. The two weakened lines may include perforations, or a crease, scores, or other areas of weakness that facilitate folding along the weakened lines. Folding along the at least two weakened lines can allow the food product surface to fold a thicker food product that is in contact with the food product surface. Furthermore, there can be a pair of spaced apart susceptor free zones on the food product surface with susceptor material therebetween, each having its own fold line of weakness.

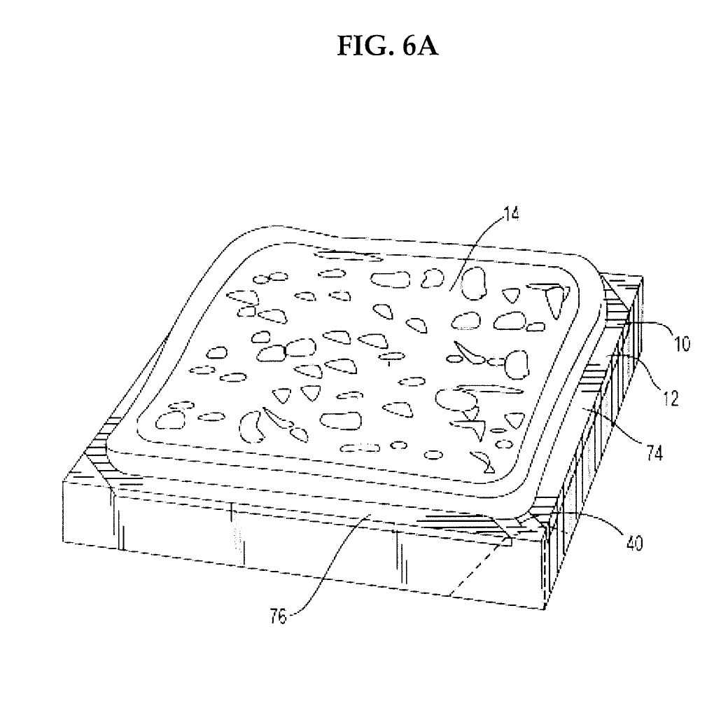

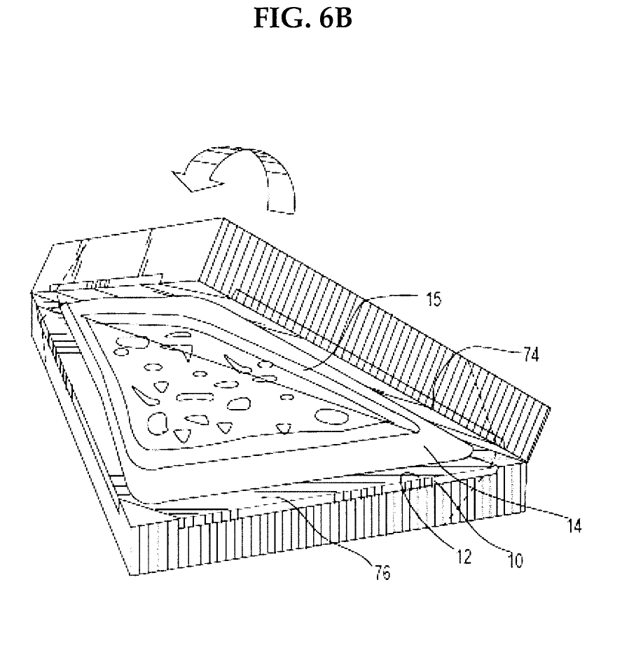

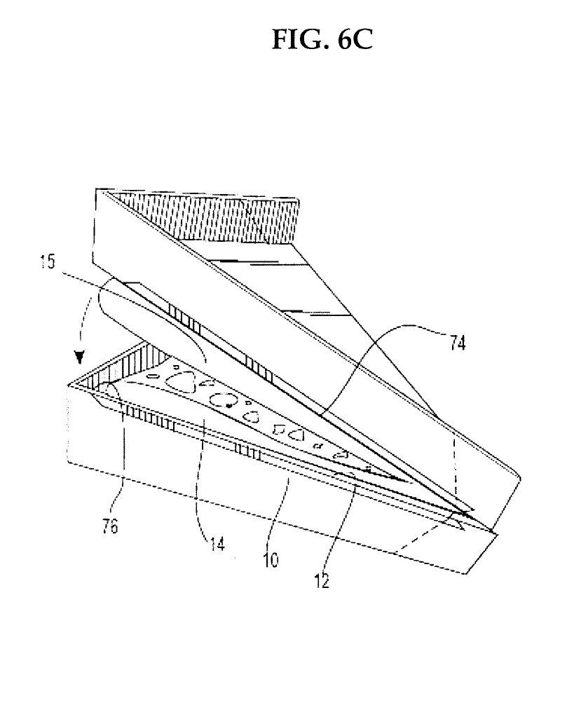

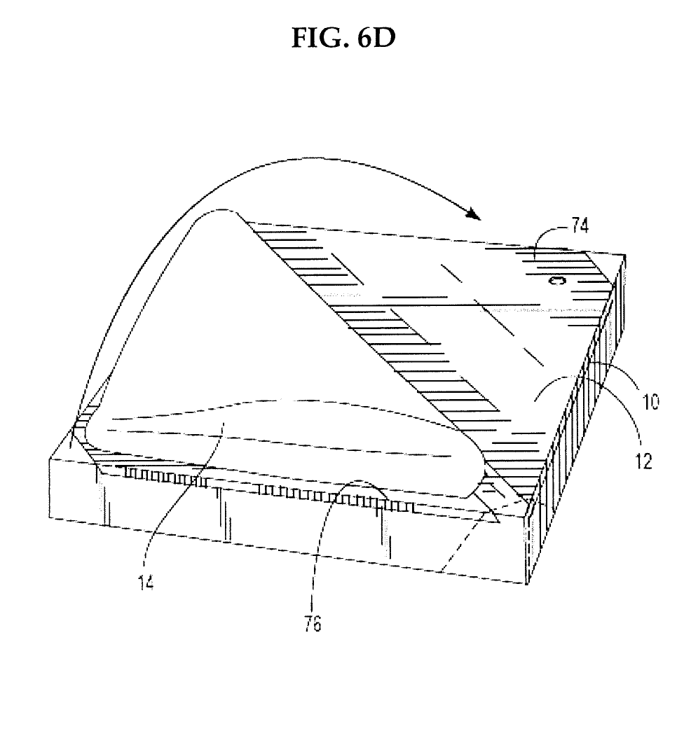

The food product surface 12 can be used to fold the food product 14 thereon by moving the surface 12 from an initial open position, suitable for cooking; to a folded position; and back to the initial open position, leaving the folded food product on one half of the surface 12. In FIG. 6A, a first portion 74 and a second portion 76 of the food product surface 12 are separated by the weakened line 40 and the food product 14 rests on both the first portion 74 and the second portion 76 of the food product surface 12. In FIG. 6B and FIG. 6C, the first portion 74 contacts a portion of the food product 15 and can be folded about the weakened line 40 into close proximity with the second portion 76, which causes the portion of the food product 15 to move and position the food product 14 into a folded position. If necessary, and depending on the thickness of the food product 14, the first portion 74 may be folded to a position nearly parallel to the second portion 76 to position the food product 14 in the folded position. As illustrated in FIG. 6D, the first portion 74 of the food product surface is folded back to its initial position and the food product 14 is left in the folded position.

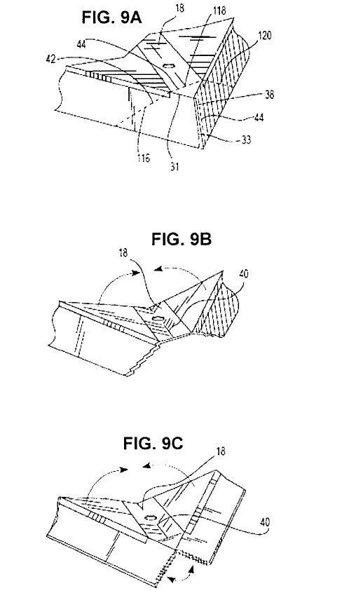

The continuous sidewall 24 is initially configured to provide stability to the food product surface 12 during cooking and to prevent folding of the food product surface 12. This permits the food product surface 12 to support the food product 14 in an elevated position while cooking and handling during removal from the microwave oven following cooking without collapsing under the weight of the food product 14 resting thereon. After cooking is completed, the food product surface 12 may be configured to permit folding by breaking portions of the sidewall 24. In one configuration, the corners adjacent a diagonally extending line of weakness may be removed, as illustrated in FIG. 9B. In another configuration, suitable for both diagonally extending and side-to-side lines of weakness, the adjacent portions of the sidewall may be broken, as illustrated in FIG. 9C. Furthermore, these two configurations can be combined in one raised platform 10, as illustrated in FIG. 9A. While these two configurations are discussed herein with reference to being combined, they could also be provided separately.

One way of breaking the sidewall 24 to permit folding of the food product surface 12 along its weakened fold line 40 is to separate the sidewall 24 along a pair of weakened lines 38 formed therein and aligned with the weakened fold line 40, as illustrated in FIGS. 9A and 9C. In the illustrated example having a diagonally-extending weakened fold line 40, the weakened lines 38 are positioned in the sidewall 24 adjacent each corner adjacent to each end of the weakened fold line 40. The weakened lines 38 may contain perforations 44, or creases, scores, or other areas of weakness that will allow breaking or tearing of the weakened line 38 in order to permit the sidewall 24 to be broken into two or more portions, which in turn permits folding of the food product surface 12 along its weakened fold line 40.

Another way of breaking the sidewall 24 to permit folding of the food product support surface 12 along its weakened fold line 40 is to remove the corner regions adjacent each end of the diagonally-extending weakened fold line 40. The corner regions are initially joined to the remainder of the raised platform 10 via a weakened corner line 42, which may contain perforations 44, or creases, scores, or other areas of weakness that will enable a user to break the weakened line 42. More specifically, the weakened corner line 42 includes surface line 118 extending between periphery edges of the food product surface 12 and generally orthogonal relative to the weakened fold line 40. An aligned weakened sidewall line 116 extends in one of the sidewall segments 28 from the surface line 118 at the periphery edge of the food product support surface 12 to the opposite longitudinal edge of the segment 28. Although not required, the weakened sidewall line 116 may extend at an inclined angle away from the corner 36. A similar weakened sidewall line 120 is located in the adjacent segment 34. This same structure of the weakened corner line 42 is also at the opposite corner at the opposite end of the diagonally-extending weakened fold line 40. Removal of the corner regions along the weakened corner lines 42 permits the sidewall 24 to be broken into two or more portions, which in turn allows the food product surface 12 to be folded along its weakened fold line 40.

Handling features may optionally be associated with the food product surface 12 to allow a user to fold the food product surface 12, and the food product 14 thereon after cooking without contacting the susceptor material 46. For instance, the food product surface may include susceptor free areas 98 that an individual can grasp to fold the food product surface 12, as well as any food product thereon. The susceptor free areas 98 may be located at corner regions of the food product surface 12 and at a position spaced from the fold region 18 by the susceptor material 46. The susceptor free areas 98 may be generally triangular in shape with a first side bordering a portion of a first outer periphery edge 124 and a second side bordering a portion of a second outer periphery edge 126 of the food product surface 12 and a third side 128 bordering the susceptor material 46. The individual may grasp at least one of the susceptor free areas 98 to fold the food product surface 12 about the weakened line 40. By not having susceptor material in the susceptor free areas 98, those areas 98 will not be as hot as other areas along susceptor material following microwave heating.

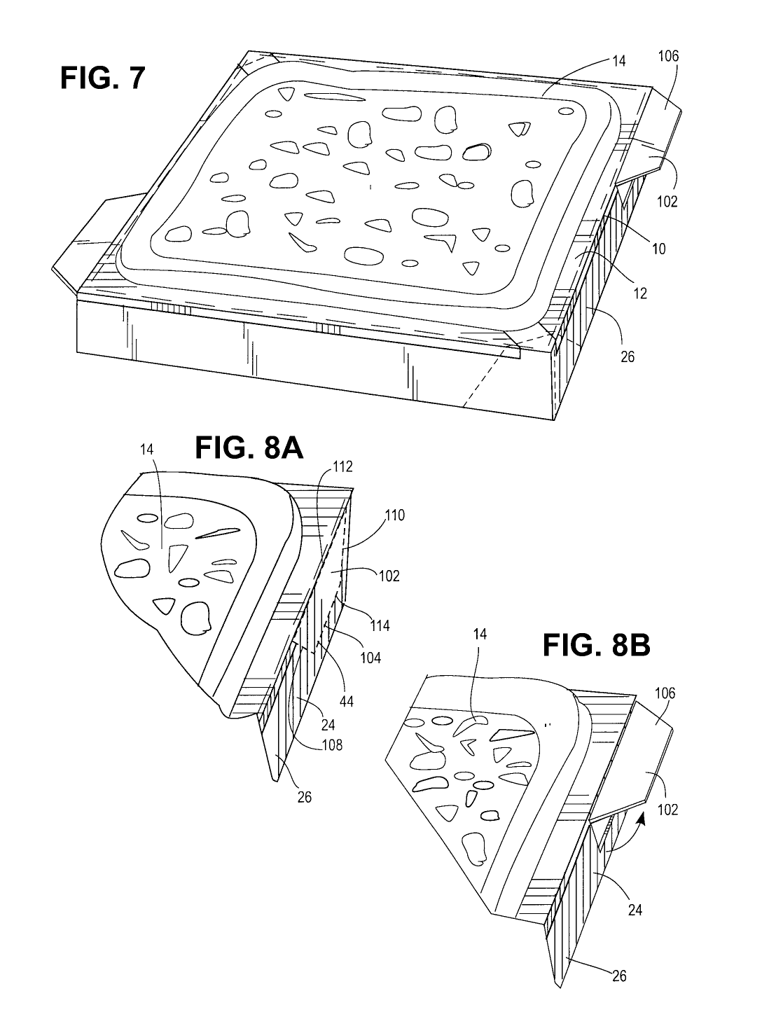

Additionally, portions of the sidewall 24 in FIGS. 7-8 may extend outward to allow an individual to grasp and fold the food product surface 12 without contacting the suscepter material 46. A flat portion 102 may be disposed on a segment 26 and include a series of connected weakened lines 104 or, alternatively, die cuts that require no or minimal breaking. The weakened lines 104 may include perforations 44, or creases, scores, or other areas of weakness that allow the weakened lines 104 to be folded or broken apart. The weakened lines 104 may be broken apart and folded such that an individual can grasp the flat portion 102 as a handle 106 to fold the food product surface 12. Specifically, the weakened lines 104 may include transverse line 108, opposite transverse line 110, a top line 112, and bottom line 114. Transverse line 108 and opposite transverse line 110 may be located on the segment 26 and extend in a direction that is generally transverse to the longitudinal edge 31 of the segment. Top line 112 and bottom line 114 may be located on the segment 26 and extend in a direction that is generally parallel to one another as well as the longitudinal edge 31 of the segment. In one example, transverse line 108, opposite transverse line 110, and the bottom line 114 in FIGS. 8A-8B are broken and separated so as to detach a section of the flat portion 102 from the segment 26. The top line 112 may remain attached and connected to the segment 26. The flat portion 102 is then folded about the top line 112 until the flat portion 102 extends outwardly from the segment 26 to a position generally parallel to the food product surface 12. Preferably, an opposite segment or adjacent segment will contain a similar flat portion capable of being folded outward from the segment and used as a handle 106. This enables the individual to grasp the handles and fold the food product surface 12 without contacting the susceptor material 46.

Turning to one example of the construction of the raised platform 10, opposite segments 30 and 34 each have flaps 37 and 39, respectively, at each of their transverse edges 33 that can be folded and adhered to inner surfaces of the other segments 28 and 32. Specifically, the second segment 30 has a pair of flaps 37 at each transverse edge 33. Both of the flaps 37 are folded inwardly, and one is adhered or otherwise affixed to the inner surface of the first segment 28 and the other is likewise adhered or otherwise affixed to the inner surface of the third segment 32. The fourth segment 34 has a pair of flaps 39 at each transverse edge 33. Both of the flaps 39 are folded inwardly, and one is adhered or otherwise affixed to the inner surface of the first segment 28 and the other is likewise adhered or otherwise affixed to the inner surface of the third segment 32, at opposite end portions from where the flaps 37 are attached.

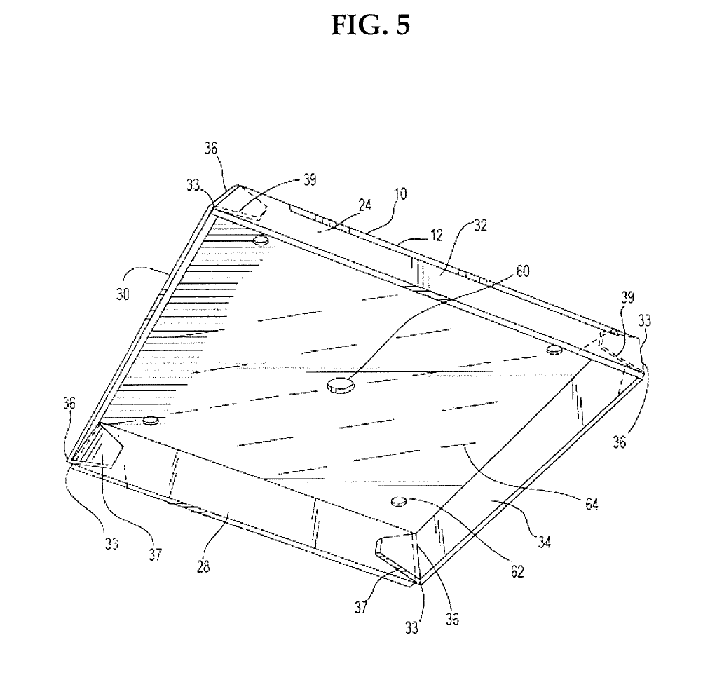

Vents may be disposed at locations throughout the food product surface 12 to provide air flow and allow moisture to vent during microwaving and to provide the optimal environment for cooking and heating of the food product 14. Some of the vents may be disposed on the area free of susceptor material 48. Vents 60 in FIG. 4 and FIG. 5 may be generally circular and of varying sizes and may be disposed within the fold region 18. The vents 60 may be positioned towards the center of the fold region 18 and may be equally spaced on each side from the susceptor material 46. Moreover, susceptor vents 62 and slit vents 64 may be disposed on the susceptor material 46. Susceptor vents 62 are generally circular and may be positioned toward the outer periphery edge 47 of the food product surface. Slit vents 64 are generally rectangular and may form narrow slits that ext end parallel to the fold region 18. Other vent patterns and shapes can be equally suitable.

The food product surface 12 is configured to be used for cooking and then folding of a food product 14 by folding the food product about a flexible fold zone located on the food product. In one example, the user may place the food product 14 on the food product surface 12 of the raised platform 10 and place the platform 10 with the food product 14 thereon in a microwave oven for heating or cooking. The food product 14 is crisped or browned in response to the heating or cooking in the microwave oven in areas that are in contact with the susceptor material disposed on the food product surface 12. However, the food product 14 is not crisped or browned in areas where it is not in contact with the susceptor material 46. In one example, the food product surface 12 includes an area free from susceptor material along a fold region 18 that allows the food product 14 to experience a lesser degree of conductive heating within a fold zone of the food product 14 and therefore more flexible for folding along the fold zone. After cooking, the user may remove the raised platform 10 and the food product 14 from the microwave oven. The user may break weakened lines 38 disposed on the legs 20 and separate adjacent segments of the sidewall to allow the folding of the food product surface 12 and the food product 14. Alternatively, the user may break the weakened corner line 42 to remove the corners which extend at the opposite edges of the fold region 18. This configuration allows the food product surface 12, and the food product 14, thereon to be folded. Handling features are provided that allow the user to fold the food product surface 12 and the food product 14 without contacting the susceptor material. In one example, optional susceptor free corners are available for the user to grasp to fold the food product surface 12 and the food product 14. In addition or in the alternative, a user may grasp optional handles that extend outwardly from a flat portion located on the sidewall segments to fold the food product surface 12 and the food product 14. The user may grasp these handling features to fold the food product surface 12 and the food product 14 and position the food product 14 in a folded position, such as illustrated in FIG. 7.

In one example of a raised platform 10, the food product surface 12 may be generally rectangular and about 6.5 inches long by about 6.5 inches wide, and the legs 20 may have a height of about 1 inch. By way of example, food products that can be cooked using the raised platform 10 include a flat-bread product, pizza crust, pita bread, naan, gyro, taco, and the like, having a bread or dough formulated bottom with toppings thereon. The susceptor material 46 can provide browning or crisping of the bottom of the food product during microwave heating, with the exception discussed herein of the fold zone. After heating, the food product surface 12 can be folded to fold the food product and place the toppings on top of each other.

Although preferred packaging and/or cooking arrangements are described in detail above (as well as in the related provisional application incorporated by reference above), those skilled the art will realize that many different packaging and/or cooking arrangements can be used.

The examples that follow are intended to illustrate the invention and not to limit it. All percentages used herein are by weight unless otherwise indicated. All patents, patent applications, and literature references cited herein are hereby incorporated by reference in their entirety.

### EXAMPLES

### Example 1

This Example demonstrates a quantitative difference in the crispness of the top and bottom of a flatbread product made with dough incorporating fat chips and wheat protein isolate in accordance with the invention in comparison with Lean Cuisine's® Flatbread Melts.

Inventive Flatbread. Inventive flatbreads were prepared according to the following method. The ingredients listed below in Table 2, excluding the fat chips, were combined and mixed at about 30-50 rpm in a horizontal mixture until the ingredients were blended (approximately 1 minute). The dough was then mixed at about 70-100 rpm for about 6 minutes and tested for development (i.e., viscoelasticity). Then the fat chips were added and the dough was mixed for an additional 1 minute at 70-100 rpm; it was necessary to reduce the dough temperature to about 65-70° F. to prevent melting of the fat chips during mixing. Although this reduction of the dough temperature allowed this softer fat chip to be used, harder fat chips are preferable used (see Example 2 below).

The dough was then rested for about 10 minutes while covered. Then the dough was sheeted using a conventional sheeting line and then cut to squares of about 85 to 91 grams. After proofing for 24 minutes at 80° F. and 25% relative humidity, the dough was pressed using die for about 5 seconds (bottom temperature of about 400° F.). The pressed dough was then depanned and baked in a dual zone oven (zone 2 at about 660° F. and zone at about 600° F.) with a dwell time of about 70 to 75 seconds. The baked dough was then frozen. A topping containing honey mustard sauce, chicken, bacon, tomato, Monterey jack cheese, and mozzarella cheese was then added and the completed product was frozen. The bread was about ¼ to ⅜ inches thick and the topping ranged from about ¼ to ½ inch thick.

TABLE 2

| Ingredient | Amount (% flour basis) |
|---|---|
| Wheat flour | 100 |
| Compressed yeast | 2.5 |
| Salt | 1.5 |
| Sugar | 1.0 |
| Wheat protein isolate (Arise 5000) from MGP | 0.20 |
| Ingredients | |
| Vital wheat gluten | 2.0 |
| Water | 58 |
| Corn oil | 4.0 |
| Fat chips (Palm chips from Golden Brand) | 7.0 |

Twenty inventive flatbreads with toppings were prepared as described above. Ten of the samples were and used to test the texture of the top of the flatbread (e.g., the side of the flatbread from which the food toppings were removed) and ten were used to test the texture of the bottom of the flatbread (e.g., the side of the flatbread against the susceptor). Six measurements were performed per sample using a calibrated TA-XT2 Texture Analyzer from Texture Technologies Corp., Westchester County, NY, equipped with a 2 mm probe.

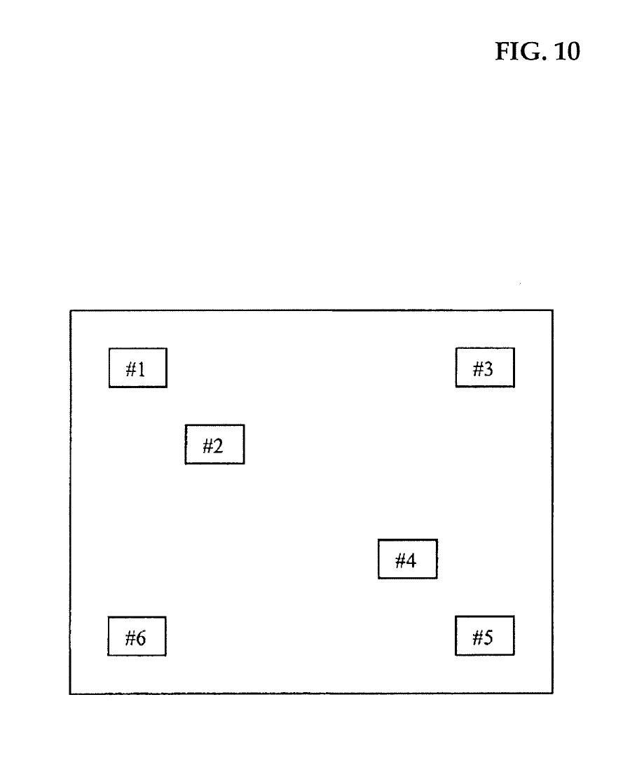

As shown in FIG. 10, a six by six inch transparent template was used to replicate testing positions across all tests. The numbers on the template represent the number and order of the tests. Test positions 1, 3, 5, and 6 are inset 1 inch from the corner of the template and 2.75 inches from the center of the template. Test positions 2 and 4 are inset 2 inches from the respective nearest corners and 1.18 inches from the center of the template.

The tests were conducted by laying the template on top of the flatbread and aligning the hole of the template with the position of the probe. The peak force of compression was recorded at the point when the probe punctures the surface of the flatbread (typically the first peak on the graph).

The flatbread was microwaved from frozen state (e.g., without prior thawing) for 2 minutes, 45 seconds using on a tray having a susceptor surface in a 1100 watt microwave. The flatbread and susceptor was then removed from the microwave and placed on the countertop without removing the susceptor. A rubber spatula was used to remove the toppings from the surface of the flatbread.

The flatbread was then removed from the susceptor and placed on the stage of the texture analyzer with either the top or bottom of the flatbread facing up. The template was then placed on the surface of the flatbread; one of the test positions indicated by the template was aligned with the texture probe. The compression force was then measured using the texture analyzer (pretest speed: 1.0 mm/sec; test speed: 1.7 mm/sec; post test speed: 10 mm/sec; distance: 70% of measure; and load cell: 5 kg). The flatbread was then repositioned so that all test positions were measured in turn; all measurements were made within 5 minutes of removing the flatbread from the microwave.

Comparison Product: Lean Cuisine® Flatbread Melt. A commercially available “Chicken Ranch Club” flatbread melt from Lean Cuisine® was used for comparison purposes. The crust was about 0.25 inch thick and the topping was about ⅛ to ¼ inch thick, depending on the location of measurement. The product was circular with about a 6 to 6.25 inch diameter. The topping included chicken, tomato, bacon, cheddar, mozzarella, and ranch sauce. The product was cooked in a similar microwave oven as above according to the cooking instructions printed on the packaging and then prepared for testing as above.

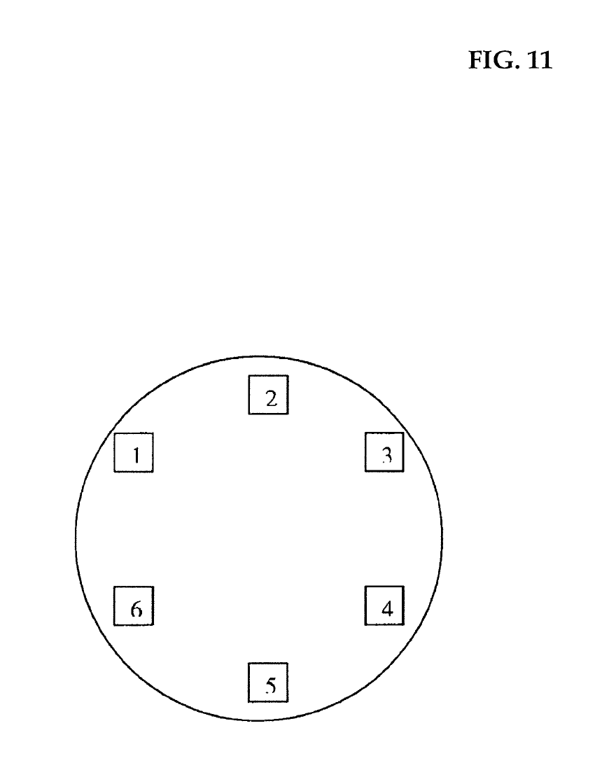

A 6.5 inch diameter transparent template (see FIG. 11) was used to determine testing positions across all tests. The numbers on the template represent the number and order of the tests. All test locations were 2.36 inches from the center of the template and about 1 inch from the perimeter of the plate. Tests were carried out in the same manner as described above.

The results obtained from positions 2 and 4 of the inventive flatbread differed considerably from the positions closer to the edge of the flatbread; this is thought to occur because the bread at positions 1, 3, 5, and 6 had considerably more brown spots than at positions 2 and 4. The averages for the inventive flatbread were compiled from a total of 40 replicated tests per location. The averages for the Lean Cuisine® Flatbread Melts were compiled from a total of 12 replicated tests per location.

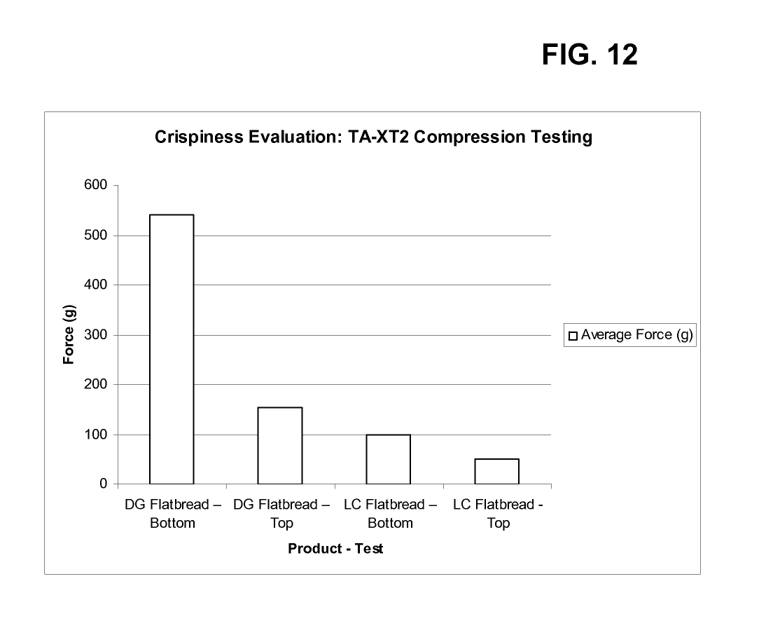

The average results of the tests are provided in the table below and in FIG. 12:

| | | | | Change from |
|---|---|---|---|---|
| | | Average | Standard | Top/Bottom |
| Product - Test | | Force (g) | Deviation | (g) |
| Inventive | Bottom surface | 541.48 | 310.212 | 388.24 |
| flatbread | Top surface | 153.24 | 163.89 | |
| Lean Cuisine ® | Bottom surface | 99.11 | 31.88 | 48.55 |
| flatbread | Top surface | 50.56 | 11.33 | |

The texture analyzer results indicate a significant and distinguishable difference in texture and crispiness between the top and bottom crusts of the inventive flatbread. The average change in compression force between the bottom and top of the inventive flatbread was almost 400 grams. The average change in compression force between the bottom and top surfaces provides an indication of the degree of dual texture obtained in the present invention. Generally, this average change in compression force between the bottom and top surfaces for the inventive product is at least about 100 grams and preferably at least about 200 grams.

The Lean Cuisine® Flatbread Melts had a much smaller difference in texture and crispness for the top and bottom surfaces of was not found. In fact, the average change in compression force between top and bottom of the Lean Cuisine® Flatbread Melts was only about 50 grams.

The average change in crispiness resulting from the inventive susceptor technology and dough formulation resulted was nearly eight times greater than the Lean Cuisine® Flatbread Melt.

### Example 2

This Example illustrates the preparation of flatbread products using fat chips from various suppliers. The fat chips varied in both size and firmness. The resulting flatbread products were evaluated for mouthfeel, crispness of the bottom surface (i.e., the surface of the flatbread contacting the susceptor during microwave cooking) and airiness of the remainder of the flatbread. The flatbread products were prepared according to Example 1 with the exception that the dough temperature was controlled to 70-75° F. for butter chips and 65-70° F. for palm chips to prevent melting of the fat chips during mixing. The results are shown in the following table.

| | | | | | Mettler | | Diameter* | | | | |
|---|---|---|---|---|---|---|---|---|---|---|---|
| | | | Solid Fat | | Dropping | Thick- | (cross | | | | |
| | | | Index (%) | | Point | ness* | section; | | | | |
| Sample | | Supplier | 50° F. | 80° F. | (° F.) | (mm) | mm) | Ingredients | Hardness** | | Results |
| 1 | Butter | Golden | 62 | 55 | 113-117 | 1.1-1.25 | 21 | Partially | 4 | Chips stay intact | Best texture; |
| | chip | Brands | | | | | | hydrogenated | | | light and airy; |
| | | | | | | | | soybean and | | | crust is very |
| | | | | | | | | cottonseed oil | | | crispy after |
| | | | | | | | | | | | microwaving |
| 2 | Palm | Golden | 71-79 | 35-42 | 125-132 | n/a | ~10-20 | Palm oil | 2 | Chips smeared; | Denser and not as |
| | chip | Brands | | | | | | | | surface very | crispy as Sample 1 |
| | | | | | | | | | | sticky | |
| 3 | HB-112 | ACH, | 68-75 | 46-50 | 110-114 | n/a | ~15-25 | Hydrogenated | 4 | Chips stay intact | Good texture but |
| | Flakes | Inc. | | | | | | palm oil | | | waxy mouth feel |
| 4 | Dritex S | ACH, | n/a | n/a | 150-160 | n/a | ~5-10 | Fully | 5 | Chips stay intact; | Good texture; |
| | Flakes | Inc. | | | | | | hydrogenated | | very firm and | bad mouth feel |
| | | | | | | | | soybean oil | | smooth; like | |
| | | | | | | | | | | plastic material | |
| 5 | SansTrans | Loders | n/a | n/a | n/a | 0.7 | ~3-5 | Palm oil | 1 | Chips deformed | Chip is very soft; |
| | 55 Gold | Croklaan | | | | | | | | | not much solid left |
| | | | | | | | | | | | after mixing; |
| | | | | | | | | | | | flatbread is dense |
| 6 | SansTrans | Loders | 87 | 50 | 122 | 1.4 | ~15-20 | Palm oil | 4 | Chips stay intact | Good texture; similar |
| | 50 L** | Croklaan | | | | | | | | | to Sample 1; good |
| | | | | | | | | | | | mouthfeel |

*According to the supplier, 75% or more of the chips from Sample 1 have the indicated thickness and diameter. Thicknesses and diameters for Samples 2-6 were estimated. These diameters are not the effective diameters used in the specification (i.e., making the assumption that chips are spherical).
**Hardness was estimated by holding and rolling fat chips between thumb and finger with light pressure at room temperature; the scale used to estimate the hardness used 1 = softest; 5 = hardest.
***Not commercially available.

Samples 1, 2, 3, and 6 provided acceptable results with Sample 1 being the best. These fat chip types have a solid fat content of at least 45 percent at 80° F. These fat chips also stay intact after pressing with finger at room temperature. Thus, the fat chips in these samples, when incorporated into the dough, desired the desired size. Sample 4 was too soft and was either reduced to a smaller than desired size or otherwise damaged during incorporation. The fat chips of Sample 5 were too hard, thereby resulting in poor organoleptic properties.

While the invention has been particularly described with specific reference to particular process and product embodiments, it will be appreciated that various alterations, modifications, and adaptations may be based on the present disclosure, and are intended to be within the spirit and scope of the invention as defined by the following claims.

1. A dough product comprising, in baker's percentages, 100 percent flour; about 55 to about 70 percent water, about 0.5 to about 10 percent fat chips; about 0.05 to about 5 percent wheat protein isolate, and about 0.5 to about 8 percent leavening agent.

2. The dough product of claim 1, further comprising about 0 to about 8 percent oil.

3. The dough product of claim 1, further comprising about 0 to about 8 percent vital wheat gluten.

4. The dough product of claim 1, wherein the leavening agent comprises about 0.5 to about 5 percent yeast, 0 to about 2 percent encapsulated chemical leavening agent, and 0 to about 1 percent leavening acid.

5. The dough product of claim 1, further comprising about 0.5 to about 6 percent sweetener.

6. The dough product of claim 4, wherein the encapsulated leavening agent is sodium bicarbonate and the leavening acid is sodium aluminum phosphate.

7. The dough product of claim 1, wherein the dough comprises, in baker's percentages, 100 percent flour; about 58 to about 60 percent water, about 5 to about 9 percent fat chips; and about 0.1 to about 0.3 percent wheat protein isolate.

8. A frozen dual-textured bread product comprising a fully baked or par baked flatbread-type bread product having a top surface, a bottom surface, and an interior portion, wherein the baked or par baked flatbread type bread product is prepared from a dough comprising, in baker's percentages, 100 percent flour; about 55 to about 70 percent water, about 0.5 to about 10 percent fat chips, about 0.05 to about 5 percent wheat protein isolate, and about 0.5 to about 8 percent leavening agent, wherein the fat chips have a minimum solid fat content of about 45 percent at 80° F. and an average effective diameter of about 2 to 10 mm, wherein the fat chips, when the dough is being fully or par baked, melt to provide voids within the dough, wherein the leavening agent, when the dough is being fully or par baked, generates a gas which can expand the voids within the dough, wherein the fully baked or par baked flatbread type bread product is suitable for heating in a microwave oven using a susceptor from a frozen state before consumption by a consumer, and wherein, after heating in the microwave oven, the fully baked or par baked flatbread type bread product has (1) a crispy texture for the bottom surface and (2) a soft, airy texture for the top surface and the interior portion.

9. The frozen dual-textured bread product of claim 8, wherein the dough further comprises oil at up to about 8 percent.

10. The frozen dual-textured bread product of claim 8, wherein the dough further comprises vital wheat gluten at up to about 8 percent.

11. The frozen dual-textured bread product of claim 8, wherein the leavening agent comprises about 0.5 to about 5 percent yeast, up to about 2 percent encapsulated chemical leavening agent, and up to about 1 percent leavening acid.

12. The frozen dual-textured bread product of claim 8, wherein the encapsulated chemical leavening agent is sodium bicarbonate and the leavening acid is sodium aluminum phosphate.

13. The frozen dual-textured bread product of claim 8, wherein the dough comprises, in baker's percentages, 100 percent flour; about 58 to about 60 percent water, about 5 to about 9 percent fat chips; and about 0.1 to about 0.3 percent wheat protein isolate.

14. The frozen dual-textured bread product of claim 8, wherein the fully baked or par baked flatbread type bread product is a flatbread.

15. The frozen dual-textured bread product of claim 8, wherein the fully baked or par baked flatbread type bread product is a pizza crust.

16. A process for preparing a baked bread product comprising the steps of:
mixing, in baker's percentages, 100 percent flour; about 55 to about 70 percent water, about 0.5 to about 10 percent fat chips; about 0.05 to about 5 percent wheat protein isolate, and about 0.5 to about 8 percent leavening agent to form a first dough mixture;
adding about 0.5 to about 10 percent fat chips to the first dough mixture and mixing in a manner effective to provide the desired size fat chips;
resting the dough;
shaping the dough into a desired shape and amount of dough;
proofing the dough;
baking the dough to form a baked bread product;
freezing the baked bread product, wherein the frozen baked bread product is suitable for heating in a microwave oven before consumption by a consumer to provide a dual-textured bread product having a crispy outer layer while the remainder of the bread product has a soft, airy texture.

17. The process of claim 16, wherein the dough comprises, in baker's percentages, 100 percent flour; about 58 to about 60 percent water, about 5 to about 9 percent fat chips; and about 0.1 to about 0.3 percent wheat protein isolate.

18. The process of claim 16, wherein the dough further comprises about 0 to about 8 percent oil.

19. The process of claim 16, wherein the dough further comprises about 0 to about 8 percent vital wheat gluten.

20. The process of claim 16, wherein the leavening agent comprises about 0.5 to about 5 percent yeast, 0 to about 2 percent encapsulated chemical leavening agent, and 0 to about 1 percent leavening acid.

21. The process of claim 16, wherein the dough further comprises about 0 to about 8 percent oil and about 0 to about 8 percent vital wheat gluten.

22. The process of claim 16, wherein the bread product is a flatbread.

23. The process of claim 16, wherein the bread product is a pizza crust.

24. A kit comprising:
(1) a frozen baked bread product; and
(2) a platform suitable for use in heating the frozen baked bread product in a microwave oven,
wherein the frozen baked bread product is prepared from a dough comprising, in baker's percentages, 100 percent flour; about 55 to about 70 percent water, about 0.5 to about 10 percent fat chips; about 0.05 to about 5 percent wheat protein isolate, and about 0.5 to about 8 percent leavening agent, and
wherein the platform comprises:
a food product support surface;
legs depending from the food product support surface;
a weakened fold line extending across the food product support surface about which the food product support surface and any food product thereon can be folded; and
susceptor material of the food product support surface disposed on both sides of a fold region of the support surface extending on both sides of the weakened fold line and the fold region being free of the susceptor material.

25. The kit of claim 24, wherein the bread product is a flatbread.

26. The kit of claim 24, wherein the bread product is a pizza crust.

27. A method of microwave cooking a bread product, the method comprising:
positioning a frozen bread product on an elevated support surface, wherein the bread product is prepared from a dough composition comprising, in baker's percentages, 100 percent flour; about 55 to about 70 percent water, about 0.5 to about 10 percent fat chips; about 0.05 to about 5 percent wheat protein isolate, and about 0.5 to about 8 percent leavening agent;
conducting heat using a pair of spaced susceptors during microwave heating to only portions of the frozen bread product spaced from a linear fold region about which the food product can be folded to maintain flexibility of the bread product about the fold region; and
folding the elevated support surface to fold the bread product about the fold region.
